(19) United States
(12) Patent Application Publication
(10) Pub. No.: US 2010/0315198 A1
(43) Pub. Date: Dec. 16, 2010

(54) FIELD DEVICE AND METHOD OF OPERATION THEREOF

(75) Inventor: Andreas Jurisch, Schwante (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/864,549

(22) PCT Filed: Jan. 24, 2008
(86) PCT No.: PCT/EP2008/000661

§ 371 Date: Aug. 10, 2010

(51) Int. Cl. G05B 19/00

(52) U.S. Cl. 340/5.2

(57) ABSTRACT

A field device, in particular a protective device for protecting, controlling or monitoring an electric switching or energy supply unit, has an access control device, controlling access to the field device. The access control device includes: a memory with access rights, roles and users stored therein, wherein each access right defines the access to at least one device value, one device parameter or one device function, one or more access rights are associated with each role, and one or more roles are associated with each user, and a control device suitable to prevent an access to a device value, a device parameter or a device function by a user when the respective user is not associated with a role with the access right required for the respective access. The control device has a test module that exclusively allows access by a user only if the access right that is required for the respective access and that is stored in the memory is provided with a valid electronic signature.

The invention relates to a field device, particularly a protective device, for protecting, controlling or monitoring an electrical switchgear or power supply unit having the features according to the preamble of claim 1.

Such a field device is described in the international patent application WO 2007/036178. This field device is equipped with an access control device which controls access to the field device. The access control device comprises a memory with access rights, roles and users stored therein, wherein each access right respectively defines the access to at least one device value, a device parameter or a device function, each role respectively has one or more associated access rights, and each user respectively has one or more associated roles. Furthermore, the access control device comprises a control device which is suitable for preventing access to a device value, a device parameter or a device function by a user when the respective user has no associated role with the access right which is required for the respective access.

The invention is based on the object of specifying a field device which provides even better protection for the field device against illegal device access and, in particular, prevents illegal device manipulation.

This object is achieved by the invention, on the basis of a field device of the type cited at the outset, by the characterizing features of claim 1. Advantageous refinements of the invention are specified in subclaims.

Accordingly, the invention provides for the control device to have a checking module which permits access by a user exclusively if the access right which is required for the respective access and which is stored in the memory is provided with a valid electronic signature.

A fundamental advantage of the field device according to the invention can be seen in that it exclusively allows access operations which are based on an authentic, unfalsified access right. Falsified access rights are recognized and blocked, so that even indirect or multistage overriding of access restrictions cannot be successful. This will be illustrated in more detail using the following example: if a user wishes to access a field device, known in advance in the prior art, even though his access rights are not sufficient for this, it is conceivable for the user to use device manipulation first of all to manipulate and extend one or more of the access rights which have been authorized for him, namely such that the extended access rights permit the desired access; such illegal access would thus be effected in a first stage by falsifying and extending existing unlocked access rights and in a second stage by activating the manipulated unlocked access rights. This is the starting point for the invention, by virtue of each device access operation involving a check being performed to determine whether the respective access right is authentic and unfalsified; only if the result of this check is positive is the requested use right activated. Multistage device manipulation, as described above, will thus be unsuccessful in the case of the field device according to the invention.

A further advantage of the field device according to the invention is that the functionality of the field device can be extended by parameterization only by authorized persons and it is likewise possible for access restrictions to be defined again for said extensions.

Preferably, the valid electronic signature is associated with an authorized access rights administrator, so that the valid electronic signature confirms that the respective access right has been released by an authorized access rights administrator.

By way of example, electronic signatures are produced by virtue of the content which is to be signed being regarded as a data sequence and said sequence being used as input information for a hash algorithm. The output information obtained is a checking code. Said checking code is then encrypted using an asymmetric encryption algorithm, for example. The encrypted hash code is the electronic signature for the content used as input information for the hash algorithm and is appended to the content.

The encryption and decryption of the hash code involve the use of a key pair, for example, comprising a private and a public cryptographic key. The issuer of the electronic signature stores his private cryptographic key used for the encryption in a certificate, for example. In order to be able to check the electronic signature, the checking party needs the public key. Said public key can be used by the checking party to decrypt the hash code, and the hash algorithm can be used by the checking party to form the hash code relating to the data sequence which is to be checked a second time. If the decrypted hash code and the self-formed hash code match, the content is unchanged. The decryption of the hash code can be successful only if the keys used for the encryption and decryption belong to the same key pair. The public key used for checking the electronic signature is subsequently referred to a checking key. Further information relating to such methods can be found at http://de.wikipedia.org/wiki/DigitaleSignatur, inter alia.

With regard to a particularly high degree of manipulation protection, it is regarded as advantageous if the field device permanently stores at least one checking key in non-overwritable form which can be used to establish the validity of the electronic signature. The proposed protection of the checking key makes it possible to prevent the checking key from being modified to begin with during multistage device manipulation so as subsequently to be able to activate falsified access rights.

In order to simplify maintenance, parameterization or other service work by authorized users, such as access rights administrators, it is regarded as advantageous if the memory is indirectly or directly addressable from the outside, particularly via a data line, and if further access rights can be stored from the outside.

Preferably, the control device will store a further access right in the memory only if said access right has a valid electronic signature and, in particular, a check on the electronic signature confirms that said access right originates from an access rights administrator which is authorized to release access rights. By way of example, the checking module checks the validity of an electronic signature from a further access right before said access right is stored using one or more checking keys which are permanently stored in the field device and which are non-overwritable.

In line with one particularly preferred refinement of the field device, provision is made for the memory to store the access rights, roles and users in a first data record, which assigns each user at least one respective role, and in a second data record, which assigns each access right at least one respective role.

Preferably, the checking module has at least one first auxiliary module, a second auxiliary module and a comparison module which is connected to the first auxiliary module and to the second auxiliary module, wherein the first auxiliary module is suitable for reading, in the event of access by a user, the role or the roles of the respective user from the first data record and for transmitting said role(s) to the comparison module, wherein the second auxiliary module is suitable for reading from the second data record those roles which have the access right which is required for the respective access and for transmitting the roles which have been read to the comparison module, and wherein the comparison module is suitable for comparing the roles which have been read by the first auxiliary module with those of the second auxiliary module and for blocking access by the user if a single role match is not established.

The invention also relates to a method for operating a field device, particularly a protective device, for protecting, controlling or monitoring an electrical switchgear or power supply unit, wherein access to the field device is controlled by means of access rights, roles and users stored in a memory, wherein each access right respectively defines the access to at least one device value, a device parameter or a device function, each role respectively has one or more associated access rights, and each user respectively has one or more associated roles, and access to a device value, a device parameter or a device function by a user is prevented if the respective user has no associated role with the access right which is required for the respective access.

In line with the invention, such a method has provision for access by a user to be permitted exclusively if the access right which is required for the respective access and which is stored in the memory is provided with a valid electronic signature. Preferably, the valid electronic signature confirms that the respective access right has been released by an authorized access rights administrator.

For the advantages of the method according to the invention and for advantageous refinements of the method, reference is made to the above comments in connection with the field device according to the invention.

The invention is explained in more detail below using exemplary embodiments; by way of example,

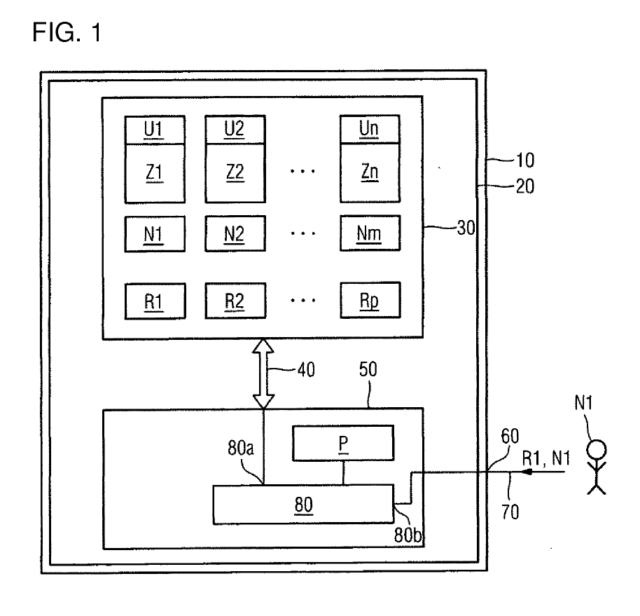

FIG. 1 shows a first exemplary embodiment of a field device according to the invention,

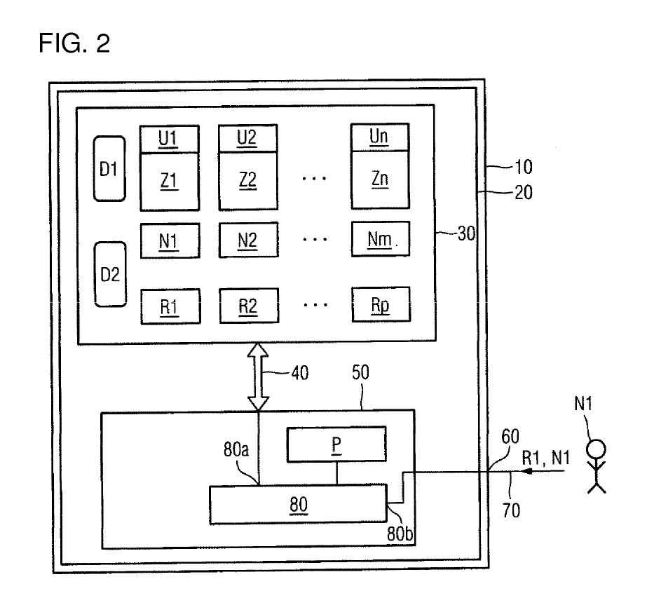

FIG. 2 shows a second exemplary embodiment of a field device according to the invention in which two separate data records for defining the association between users and roles, on the one hand, and roles and access rights, on the other hand, are defined,

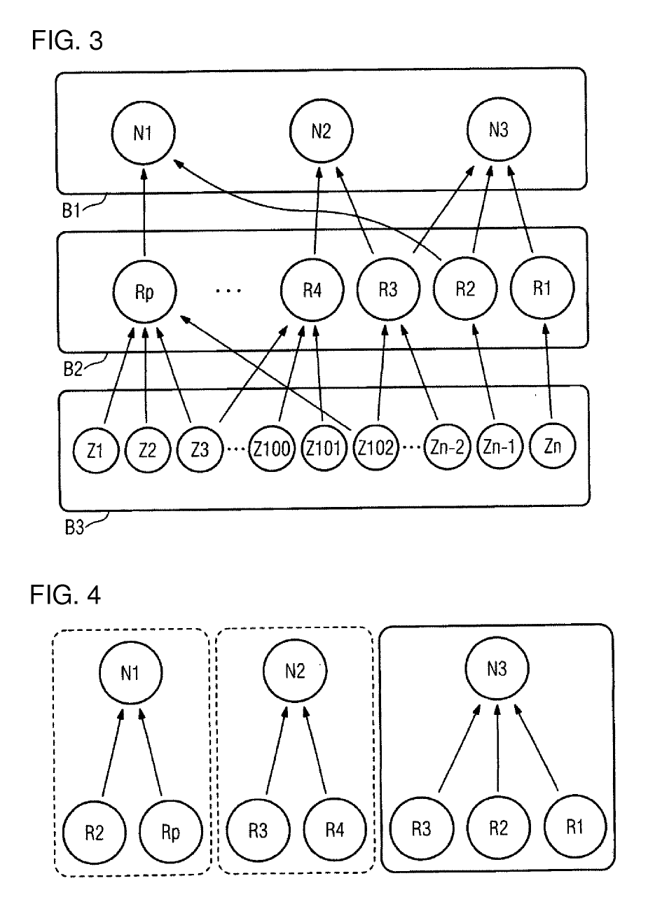

FIG. 3 shows an example of the association between users, roles and access rights using a tree structure,

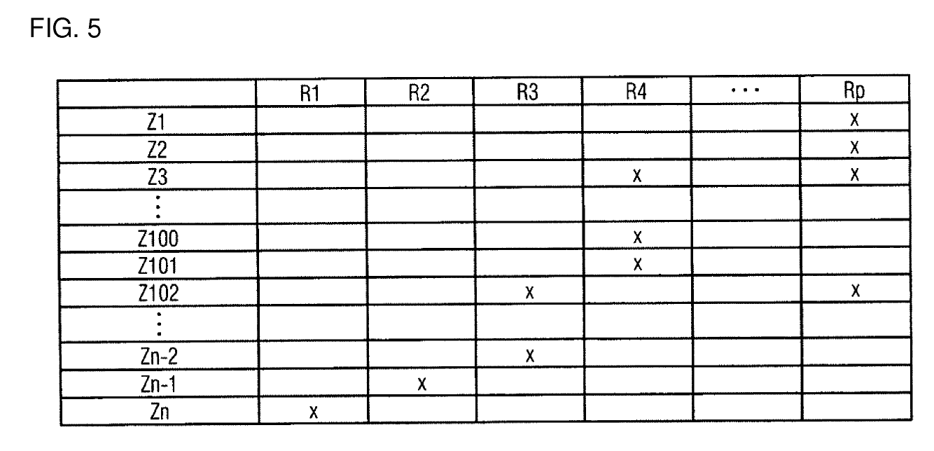

FIGS. 4-5 show an exemplary embodiment of an association between users, roles and access rights using a tree structure and also an associated table,

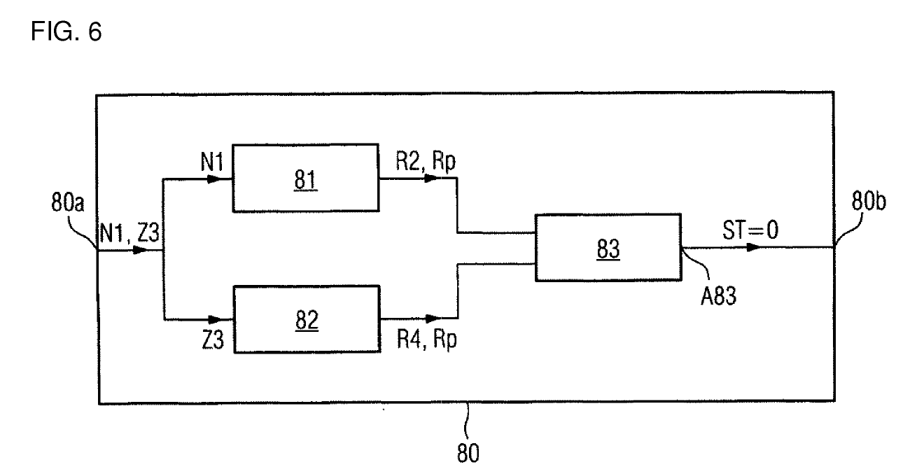

FIG. 6 shows an exemplary embodiment of a checking module in a control device for a field device as shown in FIGS. 1 and 2, and

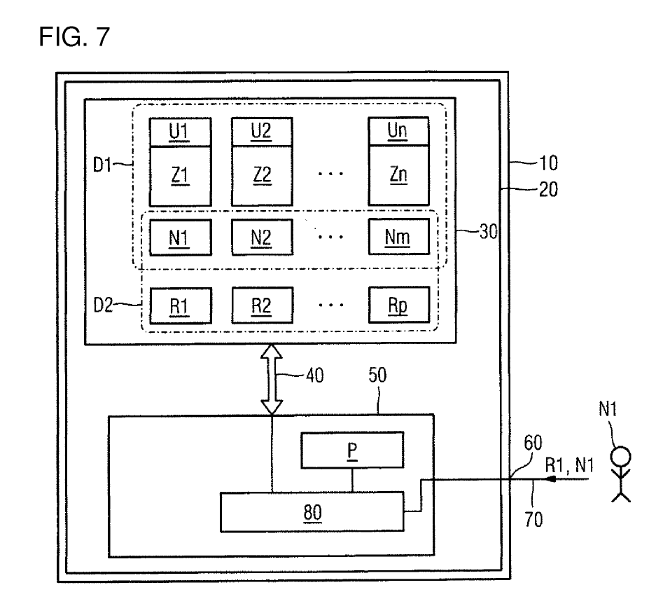

FIG. 7 shows a third exemplary embodiment of a field device according to the invention in which access rights, roles and users are stored in a different form.

For the sake of clarity, the same reference symbols are always used in the figures for identical or comparable components.

FIG. 1 shows an exemplary embodiment of a field device 10 which is equipped with an access control device 20. The other components of the field device 10 are not shown in more detail in FIG. 1, for the sake of clarity.

The access control device 20 has a memory 30 and also a control device 50 connected to the memory 30 via a bus line 40. In addition, the control device 50 is connected to a connection 60 of the field device 10. The connection 60 may have an external data line 70 connected to it, for example, which a user, for example the user N1, can use to connect to the field device 10.

FIG. 1 reveals that the memory 30 stores access rights Z1, Z2, . . . Zn. Each access right is respectively provided with a valid electronic signature; the relevant signatures are identified in FIG. 1 by the reference symbol U1, U2, . . . Un. By way of example, the electronic signatures U1 to Un may be digital signatures produced using the RSA method.

In addition, the memory 30 stores users N1 to Nm and roles R1 to Rp. Each role R1 to Rp has one or more respective associated access rights Z1 to Zn, and each user N1 to Nm has one or more respective associated roles R1 to Rp. The access rights Z1 to Zn respectively define the access to at least one device value, a device parameter or a device function of the field device 10.

The control device 50 is equipped with a checking module 80 which is connected to the bus line 40 and to the connection 60 of the field device 10. Furthermore, the checking module 80 has access to one or more checking keys P, which may be stored either in the control device 50 or at another location—for example the memory 30—in the field device 10. In the exemplary embodiment shown in FIG. 1, a single checking key P is stored in the control device 50 by way of example.

The checking key P is permanently stored preferably in a non-overwritable form in order to prevent manipulation of the checking key P during access from the outside. The checking key P may be stored in the form of an X.509 certificate, for example.

By way of example, the field device 10 can be operated as follows:

If the user N1 wishes to access the field device 10 in the role R1, he will register with the control device 50 via the connection 60. For such registration, the control device 50 will first of all check whether the user N1 has access authorization. By way of example, such an access authorization check can be performed with password and certificate protection, as explained in the international patent application WO 2007/036178 mentioned at the outset, for example. If the control device 50 establishes, during this access check, that the user N1 is authorized to access the field device 10, it will subsequently check whether the user N1 in the memory 30 has the associated role R1 desired by the user N1. If this is not the case, the control device 50 will deny access, otherwise it will grant access.

If the user N1 now wishes to use the access right Z1 in the role R1 and sends an appropriate request to the field device 10 via the data line 70, the control device 50 will check whether the role R1 of the user N1 has the associated access right Z1. If this is the case, the control device 50 will not immediately permit access, however, but rather will first of all check whether the access right Z1 which is stored in the memory 30 and which is requested by the user N1 is actually provided with a valid electronic signature U1. Alternatively, the electronic signature can be checked when the access right is actually stored in the memory 30.

The check on the signature U1 is performed using the checking key P permanently stored in the control device 50 in non-overwritable form, said checking key being able to be used to check the validity of the signature U1. This signature check can be used to confirm whether the access right Z1 stored in the memory 30 has actually been released by an authorized access rights administrator: only if this is the case and the authenticity of the access right Z1 is confirmed by the signature check will the control device 50 permit the execution of the access right Z1.

The validity or authenticity check on the access rights Z1 to Zn is used to ensure that actually only such access rights as have actually been produced or released by an authorized administrator can be exercised or activated. By way of example, this authenticity check makes it possible to prevent an unauthorized user in the memory 30 from manipulating access rights in order to allow access which is otherwise impossible. The authenticity check described thus ensures that access can be effected only using access rights which have been authorized beforehand or are authentic. Unauthorized changes to the access rights are not possible.

In order to ensure that the memory 30 is provided exclusively with access rights which have been released by an authorized access rights administrator, the control device 50 is preferably also designed such that it permits the storage of a further new access right in the memory 30 only if said access right is provided with a valid electronic signature which confirms that the access right has actually been released by an authorized access rights administrator. This check preferably also involves the use of the checking key P which is stored in the control device 50.

FIG. 2 shows an exemplary embodiment of a field device 10 in which the memory 30 stores two separate data records D1 and D2. Data record D1 is subsequently referred to as the first data record and data record D2 is subsequently referred to as the second data record.

The first data record D1 contains a definition of what role or roles each of the users can exercise. The second data record D2 contains a stipulation of what access rights Z1 to Zn each of the roles R1 to Rp may exercise. By way of example, the two data records D1 and D2 may be stored in the memory 30 in the form of a tree structure, as shown by way of example in FIG. 3.

In the case of the tree structure shown in FIG. 3, the user N1 has the associated roles R2 and Rp, the user N2 has the associated roles R3 and R4 and the user N3 has the associated roles R1, R2 and R3, for example. The roles in turn have associated access rights Z1 to Zn which can be activated by the respective role and hence by the users associated with the roles.

In the case of the tree structure shown in FIG. 3, the first data record D1 shown in FIG. 2 is thus clearly formed by the two upper blocks B1 and B2 in FIG. 3, and the second data record D2 is clearly formed by the two lower blocks B2 and B3 in FIG. 3. The middle block thus clearly belongs to both data records D1 and D2.

Instead of the tree structure shown in FIG. 3, the two data records D1 and D2 can also be defined in a tabular form. It is also conceivable for one of the two data records to be defined in the form of a tree structure and for the other data record to be defined using a table. Such a refinement is shown by way of example in FIGS. 4 and 5.

In FIG. 4, it can be seen that the first data record D1, which assigns each user at least one respective role, is stored in the form of a tree structure.

The association between the roles R1 to Rp and the access rights Z1 to Zn is made in a table, as shown by way of example in FIG. 5. In FIG. 5, the letter “X” stipulates that there is an association between role and access right; if there is no such “X” then there is no association and the relevant role is unable to exercise the respective access right.

FIG. 6 shows an exemplary embodiment of the checking module 80 in the control device 50 shown in FIGS. 1 and 2. It can be seen that the checking module 80 has a first auxiliary module 81, a second auxiliary module 82 and a comparison module 83 which is connected to the two auxiliary modules 81 and 82. The inputs of the two auxiliary modules 81 and 82 are connected to the connection 80a of the checking module 80, which is connected to the bus line 40. An output A83 of the comparison module 83 is connected to the connection 80b of the checking module 80 and hence to the connection 60 of the field device 10.

The function of the first auxiliary module 81 is to read, in the event of access by a user, for example the user N1 shown in FIG. 1, the role or the roles of the respective user N1 from the first data record D1 and to transmit said role(s) to the comparison module 83. In the event of access by the user N1, the first auxiliary module 81 will therefore request the two roles R2 and Rp from the first data record D1 and transmit them to the comparison module 83.

In the case of the described access by the user N1, the second auxiliary module 82 will read from the data record D2 all those roles which have the access right which is required for the respective access. If the user N1 wishes to activate the access right Z3, for example, in his role R1 then the request for the data record D2 by the second auxiliary module 82 will therefore have the roles R4 and Rp as the result, these being transmitted to the comparison device 83 by the second auxiliary module 82.

The comparison device 83 now compares whether the roles which are read by the first auxiliary module 81 and the roles which are read by the second auxiliary module 82 exhibit a match: if this is the case then the output A83 of the comparison module 83 produces a control signal ST which is used to release the requested access right. If an appropriate match is not established, as is the case in the exemplary embodiment, then the comparison module 83 produces a control signal ST which blocks corresponding access. By way of example, the control signal ST may be in binary coded form and may have a logic 1 when access is released and a logic 0 when access needs to be blocked.

FIG. 7 shows a third exemplary embodiment of a field device. In this exemplary embodiment, the two data records D1 and D2 are stored in the memory 30 not separately and not in addition to the access rights Z1 to Zn, the users N1 to Nm and the roles R1 to Rp, but rather are linked thereto. Specifically, the definition of the users, roles and access rights is contained in the data records D1 and D2, as shown schematically in FIG. 7. In terms of the manner of operation, the field device shown in FIG. 7 corresponds to the two exemplary embodiments shown in FIGS. 1 and 2.

The access rights Z1 to Zn described above may also be implemented, by way of example, in access modules—not shown further—which actually perform access to at least one device value, a device parameter or a device function of the field device 10; in this case, the checking module 80 would permit access by a user exclusively if the access module required for the access, with the access right implemented therein, is provided with a valid electronic signature U.

By way of example, the access rights described above may also be formed by access modules themselves which actually perform access to at least one device value, a device parameter or a device function of the field device 10; in this case, the checking module 80 would permit access by a user exclusively if the access module itself which is required for the access is provided with a valid electronic signature.

1-13. (canceled)

14. A field device for protecting, controlling or monitoring an electrical switchgear or power supply unit, comprising:
an access control device for controlling access to the field device, said access control device including:
a memory having stored therein access rights, roles, and users, each access right respectively defining access to at least one device value, a device parameter, or a device function, each role respectively having one or more associated access rights, and each user respectively having one or more associated roles; and
a control device configured to prevent access to a device value, a device parameter or a device function by a user if the respective user has no associated role with the access right required for the respective access;
said control device having a checking module permitting access by a user exclusively if the access right which is required for the respective access and which is stored in said memory is provided with a valid electronic signature.

15. The field device according to claim 14 configured as a protective device for protecting the electrical switch gear or power supply unit.

16. The field device according to claim 14, having a checking key permanently stored therein in non-overwritable form, the checking key allowing a validity of the electronic signature to be established.

17. The field device according to claim 14, wherein said memory is indirectly or directly addressable from outside the field device, and further access rights can be stored from outside.

18. The field device according to claim 17, wherein said memory is addressable via a data line.

19. The field device according to claim 17, wherein said control device is configured to store a further access right in said memory only if the further access right has an electronic signature and a check of the electronic signature confirms that the access right originates from an access rights administrator authorized to release access rights.

20. The field device according to claim 14, wherein said memory, for storing the access rights, roles and users, comprises:
a first data record, which assigns each user at least one respective role; and
a second data record, which assigns each access right at least one respective role.

21. The field device according to claim 20, wherein:
said checking module has at least one first auxiliary module, a second auxiliary module, and a comparison module connected to said first auxiliary module and to said second auxiliary module;
said first auxiliary module is configured to read, in the event of access by a user, the role or roles associated with the respective user from the first data record and to transmit the role or roles to said comparison module;
said second auxiliary module is configured to read from the second data record those roles that have the access right required for the respective access and to transmit the roles that have been read to said comparison module; and
said comparison module is configured to compare the roles that have been read by said first auxiliary module with those of said second auxiliary module and to block access by the user if none of the roles read from said first auxiliary module matches one of the roles read from said second auxiliary module.

22. A method for operating a field device for protecting, controlling or monitoring an electrical switchgear or power supply unit, the method which comprises:
controlling access to the field device by way of access rights, roles, and users stored in a memory, wherein:
each access right respectively defines access to at least one device value, a device parameter, or a device function;
each role respectively has one or more associated access rights; and
each user respectively has one or more associated roles; and
preventing access to a device value, a device parameter, or a device function by a user if the respective user has no associated role with the access right that is required for the respective access; and
permitting access by a user exclusively if the access right that is required for the respective access and that is stored in the memory is provided with a valid electronic signature.

23. The method according to claim 22, which comprises controlling access to a protective device for protecting the electrical switch gear or power supply unit.

24. The method according to claim 22, which comprises establishing a validity of the electronic signature with at least one checking key that is permanently stored in the field device in non-overwritable form.

25. The method according to claim 22, which comprises storing storing at least one further access right by writing to the memory from outside the field device.

26. The method according to claim 25, which comprises transmitting the at least one further access right to the field device via a data line.

27. The method according to claim 25, which comprises storing a further access right in the memory only the further access right has an electronic signature and a check on the electronic signature confirms that the access right originates from an access rights administrator authorized to assign access rights.

28. The method according to claim 25, which comprises checking a validity of an electronic signature from a further access right prior to storing the access right, by using one or more checking keys that are permanently stored in the field device and that are not overwritable.

29. The method according to claim 22, which comprises using the memory to store the access rights, roles and users
in a first data record, which assigns each user at least one respective role; and
in a second data record, which assigns each access right at least one respective role.

30. The method according to claim 29, which comprises, in the event of access by a user:
reading the role or the roles of the respective user from the first data record; and
reading those roles that have the access right required for the respective access from the second data record, and
comparing the roles read from the first data record with the roles read from the second data record, and blocking access by the user if none of the roles read from the first data record matches one of the roles read from the second data record.
